(19) United States
(12) Patent Application Publication
(10) Pub. No.: US 2006/0263488 A1
(43) Pub. Date: Nov. 23, 2006

(54) Snack food

(75) Inventors: David Pupko, Kfar Vradim (IL); Ronit Sklar, Arad (IL); Mark Edward Johnke, Collierville, TN (US); Rafi Nachum, Givat Avni (IL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Slim-Fast Foods Company, Division of Conopco, Inc.

(21) Appl. No.: 11/132,919

(22) Filed: May 19, 2005

(51) Int. Cl. A21D 13/00

(52) U.S. Cl. 426/94

(57) ABSTRACT

A low calorie snack food, especially a nutritious hand held snack food, with good organoleptic properties. Preferably, the snack food of the invention does not present an overall sweet impression. In one embodiment, the snack food comprises I) an outer shell, especially a shell comprising one or more cereal ingredients, and II) an inner creamy filling including no more than 25 wt. % sugar solids by weight of said filling, no more than 5 wt. % water, at least 20 wt. % lipid, said lipid comprising no more than 20 wt. %, on the total lipid content, of digestible saturated and trans fatty acid moieties, and at least 2 wt. % of a fibrous filling agent. Preferably the filling agent is dextrin. The filling preferably comprises from 30 to 45 wt. % lipid. The lipid of the filling preferably includes no greater than 10 wt. % (on total lipid) of trans- and saturated triglycerides.

### BACKGROUND OF THE INVENTION

Discussions of popular approaches to weight loss and maintenance continue to receive considerable space in the press. Weight loss has kept the public's attention in recent years, not only because of the perceived need to improve one's appearance, but increasingly in view of the emphasis placed on weight loss in the avoidance of conditions such as diabetes and heart disease.

Fortified hand-held food products such as nutrition bars and the like are convenient vehicles for replacement of a meal and for snacks intended to boost energy. Hand-held food products may be used by those seeking to lose weight either as snacks or as meal replacements.

While consumers express a preference for snacks and other foods which are more healthful and which can assist them to achieve their weight loss and other health objectives, they show little inclination to sacrifice the organoleptic properties of their favorite foods or snacks. Therefore, it is important that hand held snacks be palatable to consumers.

A favorite component of indulgence foods is a cream filling. Many cream fillings have tended to be sweet. In part, this reflects the need to use high amounts of sugars to impart the desired texture and taste to the cream. While consumers tend to enjoy sweet-tasting snacks, it is believed that many consumers wish to avoid foods having high sugar levels and prefer complex carbohydrates or other macronutrients to avoid sudden elevations in blood sugar. The prevalence of hand-held food product snacks with substantial amounts of sugar has tended to frustrate these objectives. Moreover, savory snacks may be more readily perceived as a meal replacement since most meals are of a savory character rather than sweet.

The patent and product literatures contain many mentions of hand-held snacks and ingredients therefor.

“Nutraceuticals Now,” published by The Aultbea Publishing Co, Inverness, Scotland, Spring 2002, accessed at htt://www.nutraceuticalsnow.com/issues/back/2002spring/nutriose.php on Apr. 12, 2005 reports that Nutriose® FB, available from Roquette Freres of Lestrem, France is a dextrin which is both well tolerated and stable under all acid and heat conditions encountered in food processes. The high tolerance is said to have been demonstrated in a clinical study. It is said to have no sweetness and no aftertaste. Examples of uses given are in drinks, confectionery biscuits, bars, dairy products, pastries and fruit preparations.

Nutriose® FB Technical Bulletin from Roquette America, Inc. indicates that Nutriose® FB is made by dextrinization of wheat starch and that it contains 41% of glucosidic 1,4 linkages, 32% of glucosidic 1,6 linkages, 13% of glucosidic 1,2 linkages and 14% of glucosidic 1,3 linkages. It is recommended as, among other things, a sugar free bulking agent and/or binder. Nutriose® FB is said to be an ideal component for nutrition bars and cereal bars. It is said that Nutriose® FB is especially ideal in the production of no-sugar added or low sugar products. The many listed products also include vegetarian meat substitutes and soups. Nutriose® FB is disclosed to contain less than 0.5% mono- and disaccharides. Synergy with intense sweeteners and low glycemic index are among performance characteristics said to make Nutriose® FB particularly suited for use in nutrition and cereal bars. Nutriose® FB is said to have a glycemic index of 25%.

Gaonkar US20040253347 mentions a multicomponent food which may be a shell with a filling or spread such as cream cheese.

WO 9428727 describes an apparatus and method for forming filled cereal pillows. The filling is selected from a group which can be fat based such as cheese, peanut butter or butter. The background section mentions a pillow fabricated from a puffed cereal dough with a fat based filling such as a cream based filling.

GB2363049 is directed to a food which may be coextruded. A lower water component may be cereal based and may be coextruded around a higher water component. The lower water component may be fortified to include vitamins, minerals and dietary fiber. The lower water component may be a wafer. The higher water component may also be fortified with vitamins, minerals or fibers. The high water component may be a cheese cake.

WO-A-9522906 is directed to a biscuit which may be in the form of a shell having a dairy filling.

U.S. Pat. No. 6,001,400 discloses a bagel and high fat cream cheese product which may be coextruded. The water content of the cream cheese, prior to cooking, is less than 15%, most preferably less than 5%. The cream cheese may be mixed with heat stable ingredients such as pepper, dried onion, sausage or dried fish. It may be displaced by jams or jellies. Cereal shells are mentioned. The product is bite-sized.

U.S. Pat. No. 5,641,527 is directed to a process of making a filled bagel dough product. The bagel is described at one point as a shell. The filling may be a natural, artificial or imitation cream cheese.

U.S. Pat. No. 4,762,723 is directed to a method of extruding a cooking with a filling cream having a high sugar content. At one point, an external casing is said to form a tube about an internal filling.

A coextruded hand held snack comprising a cereal shell and a sweet creamy filling having at least 30wt % sugar solids has been on sale in Israel and Europe at least since the 90's. The Israeli product is sold under the name “Cariot.”

Kemeny patent application publication US 2003/0087004 is directed to sweet and savory ready to eat food bars. A bar containing oat bran, soy protein isolate and canola oil is disclosed. Sugar and sugar-substitutes, as well as unhealthy forms of fat are said to be limited to 10 wt. %.

The website at http://www.mojobar.com/honey.html, accessed on Oct. 20, 2004 discloses the Mojo Bar of Cliff Bar, Inc. The ingredients listed for the honey roasted peanut bar are honey roasted peanuts (peanuts, evaporated cane juice, honey, salt, natural flavor), natural vitamin E, organic brown rice syrup, organic pretzels (organic wheat flour, salt, organic malt syrup, organic canola oil, yeast, baking soda), soy rice crisps (rice flour, rice bran, raisin juice concentrate, honey, salt), organic peanut butter, organic dry roasted soy beans, organic oat syrup, organic honey, organic tapioca starch, crisp rice (rice flour, rice bran, rosemary extract [natural antioxidant]), rice flour, organic sunflower seed oil, sea salt, natural vitamin E (antioxidant).

Fouache et al. U.S. Pat. No. 6,630,586 (Roquette Freres) discloses branched maltodextrins having between 22% and 35% glucosidic 1-6 linkages. The content of glucosidic linkages of 1-6 between 22 and 35% is said to give the branched maltodextrins a character of indigestibility. Certain compounds of the invention are said to be able to play the role of texturizing agents, thickening and/or gelling agents, filling or encapsulating agents, particularly in food products, in pharmaceutical or veterinary products. Acariogenic compositions are disclosed which comprise maltodextrins and polyols which can be glycerine, threitol, erythritol, xylitol, arabitol, ribitol, sorbitol, mannitol, maltitol, maltotriitol, maltotetraitol, lactitol, hydrogenated isomaltulose, and hydrogented starch. The acariogenic composition comprises between 30 and 70 wt. % branched maltodexrins and between 70 and 30% by weight maltitol. Various foodstuffs such as confectionery, pastries, pastes to be chewed, preparations based on milk, yoghurts and cakes are mentioned.

According to its abstract, Serpeloni WO 2004/043166 is directed to use of branched chain maltodextrins having between 15 and 35% of 1-6 glucoside bonds as granulation binders.

Jones U.S. Pat. No. 6,749,886 (Nellson Northern Operating Inc.) is directed to a confectionery bar providing a meal replacement which has a weight ratio of proteinaceous material and a carbohydrate material higher than 1. The bar also comprises carbohydrate material selected from the group consisting of digestible carbohydrate, poorly digestible carbohydrate, non-digestible carbohydrate and mixtures thereof. The carbohydrate material is generally added as a concentrated solution.

Funk et al. US published patent application 20040013771 is directed to a layered cereal bar. The binder may be a complex carbohydrate binder made from soy protein, fat, sweeteners, water and gelatin. Syrup is also mentioned. “Conventional maltodextrin/fat based binders” are mentioned, as well. Various flours can be included in the product. In one embodiment, the carbohydrates of the bar can comprise about 3 to 4% dietary fiber. In another, the total fiber percentage is about 5 to 10%.

Wurtman et al. US patent application publication No. US 2003/0039739 is directed to a protein-free snack foodstuff having two or more rapidly digestible carbohydrates such as maltodextrin, dextrose and starch for weight loss. Among the several product forms mentioned are food bars and non-baked, extruded food products. Fiber, which may be insoluble or soluble, such as methylcellulose, psyllium and bran from oats, corn, rice, barley, buckwheat, and/or wheat may be included. Numerous other sources of carbohydrate, including dextrin, are listed. Savory flavors can be included.

Prosise WO 01/78522 (Procter & Gamble) discloses nutritional foods said to have a balance of amino acids, fats and carbohydrates. Fiber may be included as well. Various bar products, such as a cheese-filled bar, are disclosed.

Miller et al. U.S. Pat. No. 5,356,643 is directed to cheese filled snack bars.

Bell WO 2004/017742 (New Zealand Dairy Board) is directed to food products which may include nutrition bars. Savory flavors may be used.

Scott EP 654 223 (Unilever) discloses a hand held snack which may include particulate material such as meats of mammals, fish and poultry, and a carbohydrate binder such as various flours, gums, glucose syrup, modified starches such as Zorbit. Zorbit is believed to be a maltodextrin. The product can take the form of a snack bar.

Coleman et al. US 2004/0126477 discloses a cereal bar having a binder which includes, eg., glycerine or sorbitol alone or in combination with a carbohydrate based binder such as corn syrup, corn syrup solids, molasses, honey, and the like. Suitable sweeteners which can be added include maltodextrin. Dextrin is mentioned in a discussion of a feature of the invention wherein the consumer can specify that all ingredients of a certain type, such as corn-containing ingredients, should be avoided.

Kealey et al. U.S. Pat. Nos. 6,599,553 and 6,558,713 disclose in example 18 an energy bar with maltodextrin.

Froseth et al. U.S. Pat. No. 6,592,915 is directed to a layered cereal bar. Savory flavors may be included. In one embodiment, the binder comprises, corn syrups, glycerin, sugars, (i.e., fructose, sucrose, etc.), as well as minor ingredients such as calcium, sorbitol, maltodextrin and salt.

Froseth et al. US 2002/0004749 discloses a system for selecting, ordering and distributing customized food products. Several types of customized food products are mentioned, such as “power bars.” Savory flavorings are mentioned as are maltodextrins, mentioned among carbohydrates.

Andersson WO 2004/004481 (Sudnif) is directed to a soft frozen product which may be produced as bars, balls or biscuits. Maltodextrin is mentioned as a possible stabilizer. It is said that although the products of the inventiion are generally sweet, savory products may be produced.

Although there have been many previous efforts to formulate nutrition and other food bars, it is desirable to attain a good tasting, low calorie, nutritious, creamy savory snack food, with little or modest amounts of sugar solids, so that consumers will be able to indulge in a tasty snack which lacks the elevated levels of sugar solids and of saturated and trans fatty acids which have been so prevalent in snack foods in recent years. Particularly desirable would be a nutritious, savory snack food in an unusual form.

### SUMMARY OF THE INVENTION

Applicants have discovered a low calorie snack food, especially a nutritious hand held snack food, with good organoleptic properties. Preferably, the snack food of the invention does not present an overall sweet impression. In one embodiment, the snack food comprises
I) an outer shell, especially a shell comprising one or more cereal ingredients, and
II) an inner creamy filling, the snack food including no more than 20 wt. % sugar solids by weight of said snack food, no more than 5 wt. % water, at least 10 wt. % lipid, said product comprising no more than 20 wt. %, on the total product content, of digestible saturated and trans fatty acid moieties, and at least 2 wt. % of a fibrous filling agent.

In accordance with another embodiment of the invention, the fibrous filling agent includes one or more fibrous ingredients having fewer than 70% glucosidic 1,4 linkages, more than 15% glucosidic 1,6 linkages, especially from 25% to 50%, and at least 5% each of glucosidic 1,2 linkages and glucosidic 1,3 linkages. In a preferred embodiment, the fibrous ingredient of the thickening agent comprises dextrin, most preferably wheat or corn dextrin.

The invention is also directed to the filling, per se. In a preferred embodiment, the filling comprises no more than 25 wt. % sugar solids by weight of the filling, no more than 5 wt. % water, at least 30 wt. % lipid, especially at least 35 wt. % lipid, the lipid comprising no more than 20 wt. % on total lipid content of digestible saturated and trans fatty acid moieties, and at least 2 wt. % of a fibrous filling agent.

Preferably, the filling comprises from 30 to 45 wt. % lipid. The lipid of the filling preferably includes no greater than 10 wt. % (on total lipid) of trans- and saturated triglycerides. Preferably the product includes less than 0.5 grams trans fats and less than 2.5 wt. % saturated fat moieties per serving of 28.35 g (1 ounce) of product. In order to minimize the amount of sugar solids in the product, it is desirable that the filling comprises no greater than 15 wt. % sugar solids based on the total weight of the shell, and that the filling includes no greater than 25 wt. % sugar solids based on the total weight of the filling. Preferred components for the shell include one or more of the following cereal ingredients: rice flour, wheat bran, oat flour, white wheat flour, or maize grits.

The invention also concerns a process of making the snack food by coextrusion. For instance, the snack product of the invention can be made by coextruding:
I) an outer shell and
II) an inner creamy filling. The filling may comprise no more than 25 wt. % sugar solids by weight of said filling, no more than 5 wt. % water, at least 35 wt. % lipid, said lipid comprising no more than 20 wt. %, on the total lipid content, of digestible saturated and trans fatty acid moieties, and at least 2 wt. % of a fibrous filling agent. Also, the product made by the coextrusion process may be such as to include no more than 20 wt. % sugar solids by weight of said snack food, no more than 5 wt. % water, at least 10 wt. % lipid, said product comprising no more than 20 wt. %, on the total product content, of digestible saturated and trans fatty acid moieties, and at least 2 wt. % of a fibrous filling agent.

Although the caloric balance depends in part on the intended use of the snack food, in general, the foods of the invention will have from 10 to 44% calories from fat, from 30 to ⁶⁰% calories from carbohydrates and from 5 to 35% calories from protein, based on the total calories in the product. It is also preferred that the snack foods of the invention comprise from 0 to 20%, especially 0.5 to 15%, calories from sugar solids, based on total calories in the product. Preferred snack foods according to the invention comprise essentially no artificial sweeteners.

As used herein, “sugar solids” refers to solids contributed by mono- and disaccharides.

For a more complete understanding of the above and other features and advantages of the invention, reference should be made to the following description of the preferred embodiments

### DETAILED DESCRIPTION OF THE INVENTION

The snack foods of the invention typically comprise a shell containing a filling coextruded therewith.

The shell is preferably cereal-based and can be made from one or more of rice flour, wheat bran, oat flour, white wheat flour, or maize grits. Other potential ingredients for the shell include: sugar, maltodextrin, protein (soy, milk or other) and milk powder, minerals, oils, lecithin, etc.

The filling is preferably a lipid based “cream” containing little or no water. Oils employed are preferably high in mono- and/or poly-unsaturated acid moieties and low in trans and saturated fat moieties. Among the oils may be included vegetable oils, marine oils such as fish oils and fish liver oils and algae. Possible vegetable oil sources include olive oil, soybean oil, canola oil, high oleic sunflower seed oil, high oleic safflower oil, safflower oil, sunflower seed oil, flaxseed (linseed) oil, corn oil, palm, palm kernal, coconut, rapeseed, cottonseed oils, peanut oil, evening primrose oil, borage oil, and blackcurrant oil. A blend of oils may be used, especially containing either synthetic antioxidants such as BHT and/or TBHQ or natural antioxidants such as mixed tocopherols, ascorbic acid and rosemary extract or a blend of the above. Preferred oils include Akocote LT15K fat and Akoliq 510 Fat available from Karlshamn of Karlshamn, Sweden, and the Netherlands, and mixtures thereof. Other suitable fats include Sanstrans 25 and Sanstrans C-2 available from Loders Croklaan of Channahon, Ill., USA and the Netherlands. The filling comprises 0-45 wt. % lipid, especially 30-40 wt. % lipid, based on the weight of the filling. Preferred lipids are triglycerides. Preferably, the filling includes no more than 5 wt. % water, preferably no more than 1 wt. % water.

If desired, the snack foods of the invention may contain sources of omega-3 and/or omega-6 fatty acids. Among those which may be useful are included arachidonic acid, docosahexaenoic acid (DHA), eicosapentaenoic acid (EPA), lineoleic acid, linolenic acid (alpha linolenic acid) and gamma-linolenic acid.

The filling of the invention may include protein sources. Preferred sources of protein include sources of whey protein, skimmed milk powder, whey protein isolate and whey protein concentrate, sources of rice protein such as rice flour and rice protein concentrate, and sources of pea protein. Although less preferred, soy protein may also be used.

Additional protein sources include one or more of dairy protein source, such as whole milk, skim milk, buttermilk, condensed milk, evaporated milk, milk solids non-fat, etc. The dairy source may contribute dairy fat and/or non-fat milk solids such as lactose and milk proteins, e.g. the whey proteins and caseins. In some cases it will be preferred, to minimize the caloric impact, to add protein as such rather than as one component of a food ingredient such as whole milk. Preferred in this respect are protein concentrates such as one or more of whey protein concentrate as mentioned above, milk protein concentrate, caseinates such as sodium and/or calcium caseinate, isolated soy protein and soy protein concentrate. Total protein levels within the fillings of the invention are preferably within the range of 5 wt. % to 45 wt. %, such as from 20 wt. % to 40 wt. %, based on the total weight of the filling.

The fillings may include emulsifying agents, typical of which are phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, of course, must be considered. Mono- and di-glycerides may be used as well. The emulsifiers may be present in the fillings, at levels overall of about 0.03% to 1 wt. %, preferably 0.05% to 0.7%, based on the weight of the filling. Emulsifiers may be used in combination, as appropriate.

The filling of the invention includes a filling agent. The filling agent preferably includes a fiber, particularly an at least partially digestible fiber such as dextrin. It is preferred that the fibrous filling agent is stable to typical food processing conditions, e.g., it does not hydrolyze to a substantial degree to increase the sugar content, and therefore, the sweetness, of the filler and ultimately of the product. Preferably, the fibrous component(s) of the thickening agent is well tolerated by the human digestive system and is water-soluble. The water solubility facilitates processing in manufacture of the snack foods. Fibers are useful in that they may also have favorable effects on blood sugar and on beneficial microorganisms in the intestines. Nutriose® FB, available from Roquette Freres of Lestrem, France, is a preferred dextrin.

Fibers which are suitable for the present invention preferably include fewer than 70% glucosidic 1,4 linkages, especially from 20% to 60%, and more than 15% glucosidic 1,6 linkages, especially from 25% to 50%. Preferably, the fibrous agent includes at least 5% each of glucosidic 1,2 linkages and glucosidic 1,3 linkages, especially from 10% to 30%.

Wheat is the preferred fiber source.

The fibrous filling agent preferably comprises from 2 to 20 wt. % of the filling.

In addition to dextrin, other fiber sources which may be included in the foods of the invention are fructose oligosaccharides (fos) such as inulin, guar gum, gum arabic, gum acacia, oat fiber, cellulose, whole grains, and mixtures thereof. The compositions preferably contain at least 1 gram of fiber per 1 ounce serving, especially at least 1-3 grams of fiber per serving. Preferably, fiber sources are present in the overall product at greater than 0.5 wt. % and do not exceed 20 wt. %. As indicated above, additional bulking agents such as maltodextrin, sugar alcohols, corn syrup solids, sugars, starches and mixtures thereof may also be used, subject to the desire to have an overall savory impression. Total filling agent and bulking agent levels in the products of the invention, including fibers and other bulking agents, but excluding sweeteners will preferably be from about 0% to 50%, especially from 2 to 40 wt. %. Preferred maltodextrins would have from 2- 20 DE. Some or all of the above may also be useful as processing ingredients. Maltodextrin may be present at, for example, 5-30 wt. %.

Carbohydrates can be used in the snack products of the invention at levels of from 0 to 90%, especially from 1% to 49%. As indicated above, sugars will be minimized or eliminated since the object is a savory snack, which is not sweet. Likewise, other sweet-tasting carbohydrates will also preferably be minimized or eliminated. Apart from sweeteners, the fibers and the carbohydrate bulking agents mentioned above, examples of suitable carbohydrates include starches such as are contained in rice flour, flour, peanut flour, tapioca flour, tapioca starch, and whole wheat flour and mixtures thereof. The levels of carbohydrates in the snack of the invention as a whole will typically comprise from 5 wt. % to 90 wt. %, especially from 20% to 65 wt. %.

Ideally, the filling of the invention includes few or no mono- and disaccharides. This permits formulation of the product to provide a savory impact. It is especially preferred that the filling include less than 20 wt. % mono- and disaccharide solids, particularly less than 15 wt. % mono- and disaccharide solids and most preferably less than 10 wt. % mono- and disaccharide solids.

To the extent that it is desired to include sweetness in the savory bar of the invention, natural sources of sweetness include sucrose (liquid or solids), glucose, fructose, and corn syrup (liquid or solids), including high fructose corn syrup, corn syrup, maltitol corn syrup, high maltose corn syrup and mixtures thereof. Other sweeteners include lactose, maltose, glycerine, brown sugar and galactose and mixtures thereof. Polyol sweeteners other than sugars include the sugar alcohols such as maltitol, xylitol and erythritol. Mono and disaccharide solids are typically present in the product at from 2-20 wt. %, especially 0.1-10 wt. %, especially 0.5-5 wt. %.

If it is desired to include a bulking agent in the food, a preferred bulking agent is inert polydextrose. Polydextrose may be obtained under the brand name Litesse. Other conventional bulking agents which may -be used alone or in combination include maltodextrin, sugar alcohols, corn syrup solids, sugars or starches, subject to the desire to minimize sweet carbohydrates expressed above.

Flavorings are preferably added to the snack in amounts that will impart a savory flavor. Subject to the desire to provide an overall savory impression, the flavoring may be any of the commercial flavors employed in nutrition bars or other food bars, such as varying types of cocoa, pure vanilla or artificial flavor, such as vanillin, ethyl vanillin, chocolate, malt, mint, yogurt powder, extracts, spices, such as cinnamon, nutmeg and ginger, mixtures thereof, and the like. It will be appreciated that many flavor variations may be obtained by combinations of the basic flavors. The hand held snacks are flavored to taste. Suitable flavorants may also include seasoning, such as salt (sodium chloride) or potassium chloride. Flavorings which mask off-tastes from vitamins and/or minerals and other ingredients are preferably included in the products of the invention. Preferably, flavorants are present at from 0.25 to 3 wt. % of the food, excluding salt or potassium chloride, which is generally present at from 0 to 1.5%, especially 0.1 to 0.5%.

The snack food may include colorants. Colorants are generally in the food at from 0 to 2 wt. %, especially from 0.1 to 1%.

If desired, the snack foods may include processing aids such as calcium chloride.

Carrageenan may be included in the snack foods of the invention, eg, as a thickening and/or stabilizing agent (0 to 2 wt. % on product, especially 0.2 to 1%). Cellulose gel and pectin are other thickeners which may be used alone or in combination, e.g., at 0 to 10 wt. %, especially from 0.5 to 2 wt. %.

It will generally be preferred that artificial sweeteners are not present since the object is a low calorie, savory hand held snack product. However, if it is desired to use artificial sweeteners, any of the artificial sweeteners well known in the art may be used, such as aspartame, saccharine, Alitame® (obtainable from Pfizer), acesulfame K (obtainable from Hoechst), cyclamates, neotame, sucralose, mixtures thereof and the like. The artificial sweeteners are typically used in varying amounts of about 0.005% to 1 wt. % on the product, preferably 0.007% to 0.73% depending on the sweetener, for example. Aspartame may be used at a level of 0.05% to 0.15%, preferably at a level of 0.07% to 0.11%. Acesulfame K is preferred at a level of 0.09% to 0.15%, although lesser amounts may be dictated by the desire to minimize sweetness.

Since the product of the invention is preferably a savory product wherein sweetness does not predominate, it is preferred that the product contain essentially no artificial sweeteners. “Essentially no artificial sweeteners” herein refers to that level of sweetener which does not contribute perceptible sweetness to the taste of the product. It will be recognized that this level will differ from sweetener to sweetener, particularly since certain high intensity sweeteners can impart a sensation of sweetness at very low levels.

Calcium may be present in the nutrition bars or other foods at from 0 to 100% of RDA, preferably from 10 to 30% RDA, especially about 25% RDA. The calcium source is preferably dicalcium phosphate. For example, wt. % levels of dicalcium phosphate may range from 0.5 to 1.5%. In a preferred embodiment, the product is fortified with one or more vitamins and/or minerals and/or fiber sources in addition to the calcium source. These may include any or all of the following:

Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, Calcium Carbonate, Calcium Lactate, Manganese (e.g., as Manganese Sulfate), Magnesium (e.g., as magnesium phosphate), Iron (e.g., as Ferric Orthophosphate), copper (e.g., as copper sulfate), and Zinc (as Zinc Oxide). The vitamins and minerals are preferably present at from 5 to 100% RDA, especially 5 to 50% RDA, most especially from about 15% RDA.

RDA as referred to herein is the Recommended DietaryAllowances 10^{th} ed., 1989, published by the National Academy of Science, National Academy Press, Washington, D.C.

The foods of the invention may be made by known methods. Ingredients are added to the foods at a convenient time in the processing, provided that any temperature sensitive ingredients are not exposed to temperatures which cause degradation of their components.

The hand held snacks of the invention are preferably coextruded.

The filling may be produced by mixing most of the ingredients, refining by a five roll refiner and mixing again with some additional fat and adding the lecithin and the chosen flavor. The filling is preferably refined to produce particle sizes in the range of 15-50, preferably 15-35, microns and a smooth, creamy mouth feel. The shell is produced by a cook extruder supplied with the ingredients and a small quantity of water. The filling is fed into the extruder (at the die) in parallel to the shell ingredients, so that a co extruded expanded product emerges from the die. The string of successive product may be cut to pillow shape by a crimper, and the items are further dried. Then, optionally more savory seasoning is added atop the product by application of flavored starch or gum (or a mix of them), followed by tumbling and heat application to gelatinize the mix on the snacks. Than the product is packed.

### EXAMPLE 1

The following product is made by the process described above.

SAVORY SHELL BASE FOR COEXTRUDED PRODUCT

| MATERIALS | QUANTITY (%) |
|---|---|
| Wheat Bran | 4 |
| White Wheat Flour | 17 |
| Maize Grits | 34 |
| Oat Flour | 4 |
| Rice Flour | 13 |
| Extrafine Sugar | 5 |
| Maltodextrin 2DE | 13 |
| Soy Isolate | 2 |
| Skimmed Milk Powder | 5 |
| Salt | 1 |
| Calcium Carbonate | 0.4 |
| Soybean Lecithin | 0.2 |
| Refined Soybean Oil | 1 |
| TOTAL | |

SAVORY FILLING BASE FOR COEXTRUDED PRODUCTS

| RAW MATERIALS | QUANTITY (%) |
|---|---|
| Vitamin & Mineral Mix | 3 |
| Salt | 1 |
| Soybean Lecithin | 0.5 |
| Akoliq 510 | 28 |
| Akocote LT15K | 5 |
| Savory Flavor | 5 |
| Skimmed Milk Powder | 30 |
| Maltodextrin 20DE | 13 |
| Sugar | 5 |
| Nutriose FB | 10 |
| TOTAL | 100 |

The filling and shell are used in a weight ratio of 1:1.

Unless stated otherwise or required by context, the terms “fat” and “oil” are used interchangeably herein. Unless otherwise stated or required by context, percentages are by weight.

The word “comprising” is used herein as “including, but not limited to” the specified ingredients. The words “comprising,” “including” and “having” are used synonymously.

It should be understood of course that the specific forms of the invention herein illustrated and described are intended to be representative only, as certain changes may be made therein without departing from the clear teaching of the disclosure. Accordingly, reference should be made to the appended claims in determining the full scope.

What is claimed is:

1. A snack food comprising
I) an outer shell and
II) an inner creamy filling, the snack food including no more than 20 wt. % sugar solids by weight of said product, no more than 5 wt. % water, at least 10 wt. % lipid, said product comprising no more than 20 wt. %, on the total product content, of digestible saturated and trans fatty acid moieties, said filling comprising at least 2 wt. % of a fibrous filling agent.

2. The snack food according to claim 1 wherein said inner filling comprises from 30 to45 wt. % /o lipid.

3. The snack food according to claim 1 wherein the fibrous filling agent comprises dextrin.

4. The snack food according to claim 1 wherein said shell includes no greater than 10 wt. % sugar solids based on the total weight of the shell and the filling includes no greater than 20 wt. % sugar solids based on the total weight of the filling.

5. The snack food according to claim 1 wherein said shell includes one or more of the following cereal ingredients: rice flour, wheat bran, oat flour, white wheat flour, or maize grits.

6. The snack food according to claim 1 wherein said filling according to claim 1 comprising from 2 to 20 wt. % of said fibrous filling agent, based on the weight of the filling.

7. The snack food according to claim 1 wherein said filling comprises at least 5 wt. % of said fibrous filling agent based on the total weight of the filling.

8. The snack food according to claim 1 comprising essentially no artificial sweeteners.

9. The snack food according to claim 1 comprising from 0.5 to 15% of calories from sugars, based on total calories in the product.

10. The snack food according to claim 1 wherein said shell and said filling are coextruded.

11. The snack food according to claim 1 wherein said filling is fortified with vitamins and minerals.

12. The snack food according to claim 1 comprising from 40-60 wt. % of said filling and from 60-40 wt. % of said shell.

13. The snack food according to claim 1 comprising from 2-20 wt. % sugar solids.

14. The snack food according to claim 1 comprising 5-40 weight percent protein.

15. The snack food according to claim 14 wherein at least 90 wt. % of said protein is dairy protein.

16. The snack food according to claim 1 wherein at least one said fibrous filling agent comprises fewer than 70% glucosidic 1,4 linkages, more than 15% glucosidic 1,6 linkages, at least 5% each of glucosidic 1,2 linkages and glucosidic 1,3 linkages.

17. A coextruded snack food comprising an outer shell including one or more cereal ingredients and a filling within the shell, said filling including at least one filling agent which has one or more fibrous ingredients, at least one of said fibrous filling agents having fewer than 70% glucosidic 1,4 linkages, more than 15% glucosidic 1,6 linkages, at least 5% each of glucosidic 1,2 linkages and glucosidic 1,3 linkages, said inner filling comprising from 30 to 45 wt. % lipid, based on the weight of the filling, from 2 to 20wt. % of said fibrous filling agent, based on the weight of the filling, and 10-40 weight percent protein based on the weight of the filling, said filling comprising from 40-60 wt. % of said snack food and said shell comprising from 60-40 wt. % of said snack food.

18. The snack food of claim 17 wherein said fibrous filling agent has a glycemic index of less than 60%.

19. The snack food according to claim 17 wherein the at least one fibrous filling agent includes a dextrin.

20. The snack food according to claim 17 comprising from 10 to 44% calories from fat, from 30 to 60% calories from carbohydrates and from 5 to 35% calories from protein, based on the total calories in the product.

21. A process of making a snack food comprising coextruding:
(a) an outer shell, and
(b) an inner creamy filling including no more than 25 wt. % sugar solids by weight of said filling, no more than 5 wt. % water, at least 35 wt. % lipid, said lipid comprising no more than 20 wt. %, on the total lipid content, of digestible saturated and trans fatty acid moieties, and at least 2 wt. % of a fibrous filling agent.

22. A creamy filling comprising no more than 25 wt. % sugar solids by weight of said filling, no more than 5 wt. % water, at least 35 wt. % lipid, said lipid comprising no more than 20 wt. %, on the total lipid content, of digestible saturated and trans fatty acid moieties, and at least 2 wt. % of a fibrous filling agent.
